(19) United States
(12) Patent Application Publication
(10) Pub. No.: US 2025/0310401 A1
(43) Pub. Date: Oct. 2, 2025

(54) Maximum Compare-and-Swap Remote Direct Memory Operation (RDMO)

(71) Applicant: MELLANOX TECHNOLOGIES, LTD., Yokneam (IL)

(72) Inventors: Omri Kahalon, Tel Aviv (IL); Artem Yurievich Polyakov, San Francisco, CA (US); Manjunath Gorentla Venkata, San Ramon, CA (US); Zach Tiffany, Minnetonka, MN (US); Aviad Shaul Yehezkel, Yokneam Illit (IL)

(21) Appl. No.: 18/624,176

(22) Filed: Apr. 2, 2024

(51) Int. Cl. H04L 67/1097

(52) U.S. Cl. CPC H04L 67/1097

(57) ABSTRACT

A system includes a first network device and a second network device. The first network device is to send over a network a command that (i) specifies a memory location, a compare value and a swap value and (ii) instructs that the swap value be written into the memory location only if the compare value is larger than a current value in the memory location. The second network device is to receive the command over the network, and to execute the command by reading the current value from the memory location, comparing the current value to the compare value, and, upon finding that the compare value is larger than the current value, writing the swap value to the memory location in place of the current value.

### CROSS-REFERENCE TO RELATED APPLICATIONS

This application is related to a U.S. patent application entitled “Hash Table Remote Direct Memory Operations (RDMO),” Attorney Docket Number 23-TV-1086US02; a U.S. patent application entitled “Append Remote Direct Memory Operation (RDMO),” Attorney Docket Number 23-TV-1086US03; and a U.S. patent application entitled “Remote Logging Remote Direct Memory Operations (RDMO),” Attorney Docket Number 23-TV-1086US04, all filed on even date. The disclosures of these related applications are incorporated herein by reference.

### FIELD OF THE INVENTION

The present invention relates generally to network communication, and particularly to transport-protocol based remote direct memory operations.

### BACKGROUND OF THE INVENTION

Remote Direct Memory Access (RDMA) is a transport protocol that enables network devices to transfer data to and from remote memories without host involvement. RDMA transport may operate over Infiniband™ or Ethernet networks, for example.

### SUMMARY OF THE INVENTION

An embodiment that is described herein provides a system including a first network device and a second network device. The first network device is to send over a network a command that (i) specifies a memory location, a compare value and a swap value and (ii) instructs that the swap value be written into the memory location only if the compare value is larger than a current value in the memory location. The second network device is to receive the command over the network, and to execute the command by reading the current value from the memory location, comparing the current value to the compare value, and, upon finding that the compare value is larger than the current value, writing the swap value to the memory location in place of the current value.

In some embodiments, the command is embedded in a transport protocol used by the first and second network devices. In an embodiment, the transport protocol is a Remote Direct Memory Access (RDMA) protocol. In a disclosed embodiment, the second network device is to execute the command atomically.

There is additionally provided, in accordance with an embodiment that is described herein, a network device including a network interface and processing circuitry. The network interface is to connect to a network. The processing circuitry is to send over the network a command that (i) specifies a memory location, a compare value and a swap value and (ii) instructs that the swap value be written into the memory location only if the compare value is larger than a current value in the memory location.

There is further provided, in accordance with an embodiment that is described herein, a network device including a network interface and processing circuitry. The network interface is to connect to a network. The processing circuitry is to receive over the network a command that (i) specifies a memory location, a compare value and a swap value and (ii) instructs that the swap value be written into the memory location only if the compare value is larger than a current value in the memory location, and to execute the command by reading the current value from the memory location, comparing the current value to the compare value, and, upon finding that the compare value is larger than the current value, writing the swap value to the memory location in place of the current value.

There is also provided, in accordance with an embodiment that is described herein, a method including sending from a first network device, over a network, a command that (i) specifies a memory location, a compare value and a swap value and (ii) instructs that the swap value be written into the memory location only if the compare value is larger than a current value in the memory location. The command is received over the network in a second network device. The command is executed in the second network device by reading the current value from the memory location, comparing the current value to the compare value, and, upon finding that the compare value is larger than the current value, writing the swap value to the memory location in place of the current value.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a computing system employing Remote Direct Memory Operations (RDMO), in accordance with an embodiment of the present invention;

FIG. 2 is a flow chart that schematically illustrates a method for performing a Maximum Compare-and-Swap (MAX-CAS) RDMO command, in accordance with an embodiment of the present invention;

FIG. 3 is a flow chart that schematically illustrates a method for performing a Hash-Table Get RDMO command, in accordance with an embodiment of the present invention;

FIG. 4 is a flow chart that schematically illustrates a method for performing a Table Append RDMO command, in accordance with an embodiment of the present invention;

FIG. 5 is a block diagram that schematically illustrates a computing system employing remote logging using RDMO, in accordance with an embodiment of the present invention; and

FIG. 6 is a flow chart that schematically illustrates a method for remote logging using RDMO, in accordance with an embodiment of the present invention.

### DETAILED DESCRIPTION OF EMBODIMENTS

### Overview

Embodiments of the present invention that are described herein provide improved methods and systems for performing complex operations directly in a remote memory. The disclosed techniques are referred to herein as “Remote Direct Memory Operations” (RDMO). In contrast to simple actions like remote read and write, the disclosed RDMO commands perform complex operations that may include multiple memory access operations, decisions, table and pointer manipulations, and the like.

In a typical configuration, a computing system comprises first and second network devices that communicate over a network. The first network device sends an RDMO command over the network to the second network device, and the second network device executes the command directly in a memory. The network devices may comprise, for example, Network Interface Controllers (NICs) or Data Processing Units (DPUs, sometimes referred to as “smart NICs”).

In one example, the RDMO command is a Maximum Compare-and-Swap (MAX-CAS) command. The MAX-CAS command specifies a memory location, a compare value and a swap value, and instructs that the swap value be written into the memory location only if the compare value is larger than a current value in the memory location. In another example, the RDMO command is a Hash Table get or set command, which instructs the second network device to get or set a value in a hash table. Yet another example is a Table Append command that appends a new value to the end of a table in memory. Another example relates to RDMO commands that perform fault-tolerant remote logging.

The disclosed RDMO commands enable performing complex operations in a remote memory with minimal latency (as they eliminate the need to wait multiple network round-trip times) and without requiring remote host involvement. In some embodiments, the disclosed RDMO commands are fully embedded in the transport protocol used by the network devices. For example, the commands can be implemented as extensions to the RDMA protocol.

In executing a given RDMO command, the second network device typically performs the multiple operations of the command atomically. Atomic execution of RDMO commands is important, for example, in distributed applications in which the memory is accessible to multiple clients simultaneously.

Alternative, naive solutions for performing a complex operation remotely might be to execute a sequence of conventional RDMA transactions, or to use Remote Procedure Call (RPC) techniques. Such approaches are suggested, for example, by Brock et al., in “RDMA vs. RPC for Implementing Distributed Data Structures,” Proceedings of the 2019 IEEE/ACM 9th Workshop on Irregular Applications: Architectures and Algorithms (IA3), November 2019. These approaches are, however, highly suboptimal since they incur considerable latency and communication overhead, and/or require support from a remote host.

### System Description

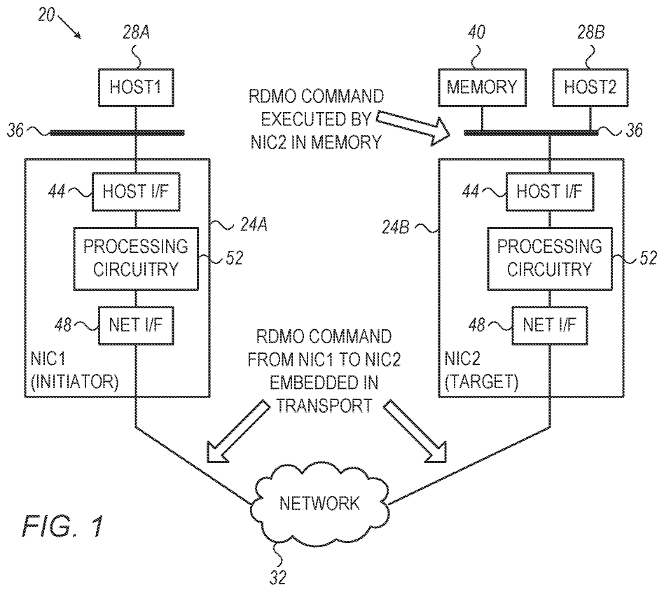

FIG. 1 is a block diagram that schematically illustrates a computing system 20 employing Remote Direct Memory Operations (RDMO), in accordance with an embodiment of the present invention. System 20 comprises network devices 24A and 24B that support RDMO commands. In the present example, network devices 24A and 24B are NICs. Generally, however, the disclosed techniques can be implemented in network devices of any other suitable type, such as DPUs (“smart NICs”), network-enabled Graphics Processing Units (GPUs), etc.

Network device 24A (denoted NIC1) serves a host 28A (denoted HOST1), and network device 24B (denoted NIC2) serves a host 28B (denoted HOST2). NICs 24A and 24B communicate over a network 32. Network 32 may comprise, for example, an InfiniBand or Ethernet network. Each NIC communicates locally with its host over a peripheral bus 36, e.g., a Peripheral Component interconnect express (PCIe) or Nvlink bus. NIC2 also communicates locally with a memory 40 over bus 36. Memory 40 may comprise, for example, a Random-Access Memory (RAM) or Flash memory.

In the examples that follow, network device 24A (NIC1) sends RDMO commands to network device 24B (NIC2) for execution in memory 40. NIC2 executes the RDMO commands in memory 40 directly, without requiring any involvement of HOST2. In this context, network device 24A (NIC1) is also referred to as an “initiator NIC”, and network device 24B (NIC2) is also referred to as a “target NIC”. The roles of initiator and target are defined for a given RDMO command. Generally, a given NIC may serve as an initiator for some RDMO commands and as a target for other RDMO commands, possibly at the same time.

As noted above, the disclosed RDMO commands are embedded in the transport protocol used by NIC1 and NIC2. In the present example, the transport protocol in RDMA. Alternatively, however, RDMO commands can be embedded in any other suitable transport protocol.

In the example of FIG. 1, each NIC comprises a host interface (I/F) 44 for communicating over bus 36, a network I/F 48 for communicating with network 32, and processing circuitry 52 that carries out the various processing tasks of the NIC, including initiation and/or execution of RDMO commands.

The configuration of system 20 shown in FIG. 1 is a simplified configuration that is chosen purely for the sake of conceptual clarity. In alternative embodiments, any other suitable system configuration can be used. For example, system 20 may comprise a large number of hosts and NICs (or other network devices) that support RDMO.

### Performing Complex Operations in a Remote Memory Using RDMO Commands

The following section describes several demonstrative examples of RDMO commands that can be supported by NIC1 and NIC2 of system 20.

### Maximum Compare-and-Swap (MAX-CAS)

In some embodiments, NIC1 and NIC2 support an RDMO command referred to as Maximum Compare-and-Swap (MAX-CAS). The MAX-CAS command specifies (i) a memory location in memory 40, (ii) a compare value and (iii) a swap value. The command instructs the target network device to write the swap value into the memory location if (and only if) the compare value is larger than the current value found in the memory location. This is in contrast to the known RDMA CAS command, which writes the swap value into the memory location if (and only if) the compare value is equal to the current value found in the memory location. The disclosed MAX-CAS command is useful, for example, to ensure that a certain value (e.g., a version number) is only increased and never decreased.

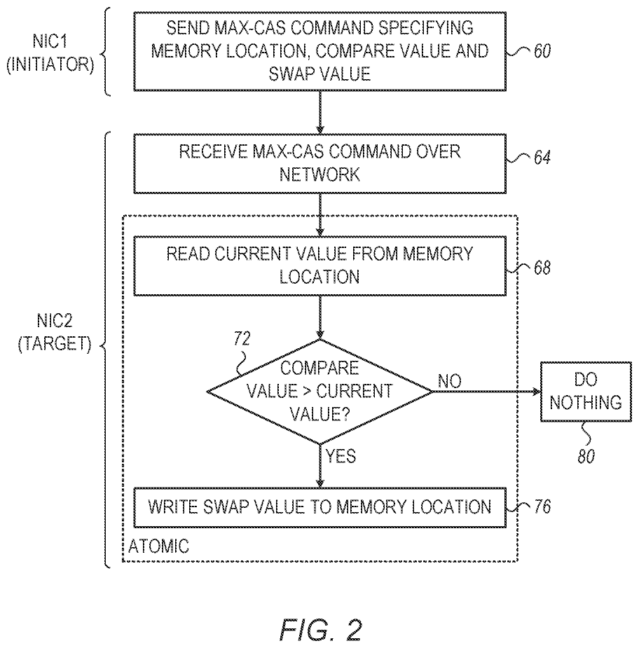

FIG. 2 is a flow chart that schematically illustrates a method for performing a MAX-CAS RDMO command, in accordance with an embodiment of the present invention. The method begins with NIC1 (the initiator NIC) sending a MAX-CAS command to NIC2 (the target NIC) over network 32, at a command sending stage 60. NIC2 receives the command over network 32, at a command receiving stage 64.

At a readout stage 68, NIC2 reads the current value from the memory location specified in the command. At a comparison stage 72, NIC2 compares the current value of the memory location to the compare value specified in the command. If the compare value is not greater than the current value, NIC2 does not change the current value of the memory location, and the method terminates at a termination stage 80. If, on the other hand, the compare value is greater than the current value, NIC2 writes the swap value specified in the command to the memory location, in place of the current value, at a writing stage 76.

NIC2 typically performs stages 68, 72 and 76 atomically, i.e., does not permit any intervening operation between them in the memory location in question. The atomicity of the operation is important, for example, when memory 40 is accessible to multiple clients.

As can be appreciated, the MAX-CAS command is highly efficient in terms of latency and communication overhead: An alternative implementation would be to first fetch the current value of the memory location to NIC1 over the network, have NIC1 compare the current value to the compare value and, if appropriate, send the swap value over the network for storage in the memory location.

### Hash Table Get/Set

In some embodiments, NIC1 and NIC2 support one or more RDMO commands that access a hash table in memory 40. Typically, NIC2 (the target NIC) is coupled to a server that hosts the hash table in memory 40, and NIC1 (the initiator NIC) is coupled to a client that accesses the hash table.

In the disclosed embodiment, the hash table is associated with a hash function that produces a hash value as a function of a key. Each hash value points to a location in the hash table. Each location in the hash table (pointed to by a respective hash value) comprises a linked list of zero or more {key, value} pairs that correspond to the hash value. If the hash table currently does not store any value corresponding to a certain hash value, the linked list of that location in the hash table is empty.

A hash-table get command instructs the target NIC to retrieve a value from the hash table, from a location in the hash table that matches a specified key. A hash-table set command instructs the target NIC to write a new value to the hash table, at a location in the hash table that matches a specified key. In both cases the command specifies the key. The target NIC calculates a hash value by applying the hash function to the key, and then accesses the location pointed to by the hash value to read or write the value.

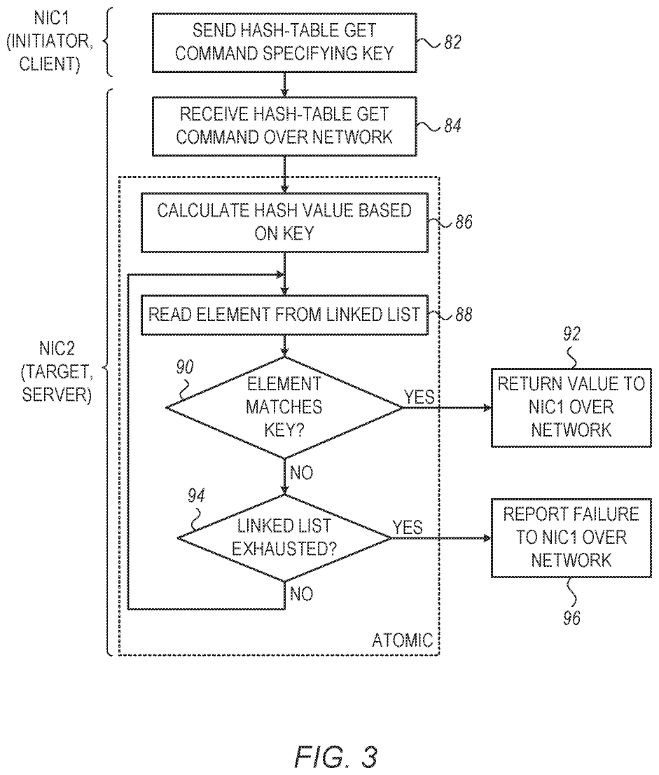

FIG. 3 is a flow chart that schematically illustrates a method for performing a Hash-Table Get RDMO command, in accordance with an embodiment of the present invention. The method begins with NIC1 (the initiator NIC) sending a hash-table get command to NIC2 (the target NIC) over network 32, at a command sending stage 82. NIC2 receives the command over network 32, at a command receiving stage 84.

At a hash calculation stage 86, NIC2 calculates a hash value by applying a hash function to the key specified in the command. The hash value points to a location in the hash table, which comprises a linked list.

At an element readout stage 88, NIC2 reads the next element ({key, value} pair) from the linked list stored at the location in the hash table pointed-to by the hash value. (In the first iteration, NIC2 reads the head of the list, which may be empty or non-empty.)

At a key checking stage 90, NIC2 checks whether the key of the currently read element ({key, value} pair) matches the key specified in the command. If so, NIC2 returns the value of the matching element to NIC1 over network 32, at a value returning stage 92, and the method terminates.

If the key of the currently read element does not match the key specified in the command, NIC2 proceeds to check whether the linked list is exhausted, at a list checking stage 94. If so, NIC2 returns a failure notification to NIC1 over network 32, at a failure stage 96, indicating that no value was found, and the method terminates. If the linked list is not yet exhausted, the method loops back to stage 88 above, and NIC2 continues to the next element of the linked list.

As with the MAX-CAS command, NIC2 typically performs stages 92, 94 and 102 atomically, i.e., does not permit any intervening operation between them in the hash table. The atomicity of the operation is important, for example, when the hash table is accessible to multiple clients. In addition, it may be necessary to protect the hash table from other modifications during execution of the Hash-Table Get command. This sort of locking can be performed in any suitable way.

The flow of FIG. 3 is an example flow that is chosen purely for the sake of clarity. In alternative embodiments, any other suitable flow can be used. For example, a hash-table set command can be executed in a similar manner.

The flows above enable accessing a remote hash table with small latency and minimal communication overhead: An alternative implementation would be to calculate the location in the table in NIC1, and then instruct NIC2 to access (read or write) the linked list at the specified location. If the first access attempt fails, NIC1 would have to instruct NIC2 to try again and fetch the next element in the linked list, and so on. This process would continue until successful or until the linked list is exhausted. As seen, such a naïve solution involves multiple round-trip transactions over network 32. Thus, for this use-case using RDMO reduces the sensitivity of the hash-table access to the number of collisions for the corresponding key.

### Table/Buffer Append

Yet another type of RDMO command, which can be supported by NIC1 and NIC2, is a command that appends a new value to the end of a buffer stored in memory 40. One typical use-case is appending a value to the end of a table. The description therefore refers to “table” and “buffer” interchangeably. In addition to the table itself, memory 40 also stores a “write pointer”-a pointer that points to the memory location in which the new value is to be appended.

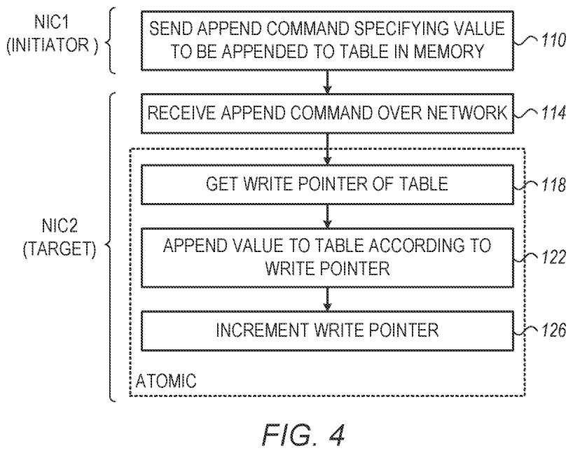

FIG. 4 is a flow chart that schematically illustrates a method for performing a Table Append RDMO command, in accordance with an embodiment of the present invention. The method begins with NIC1 (the initiator NIC) sending a table append command to NIC2 (the target NIC) over network 32, at a command sending stage 110. NIC2 receives the command over network 32, at a command receiving stage 114.

At a pointer readout stage 118, NIC2 gets the write pointer of the table from memory 40. At an appending stage 122, NIC2 appends the value given in the command, by writing the value to the location indicated by the write pointer. At a pointer incrementing stage 126, NIC2 increments the write pointer. Typically, NIC2 performs stages 118, 122 and 126 atomically.

An alternative way of appending a value to a remote table would be to perform an atomic RDMA Fetch-And-Add operation on the write pointer over the network in memory 40 by NIC2, and return the original value to NIC1, and then have NIC1 instruct NIC2 to write the new value to the location indicated by the write pointer. The disclosed RDMO command reduces the extra network round-trip and the associated latency.

### Fault-Tolerant Remote Logging

Yet another use-case that can benefit from using RDMO commands is logging software transactions. Logging, or journaling, refers to any scheme that records actions performed by a software process, e.g., for recovering the process following failure. In some embodiments, the logging functionality is offloaded to a network device (e.g., NIC), which among other benefits provides improved fault tolerance. In addition, the logging network device may log transactions running in remote hosts. The transactions are forwarded for logging using RDMO.

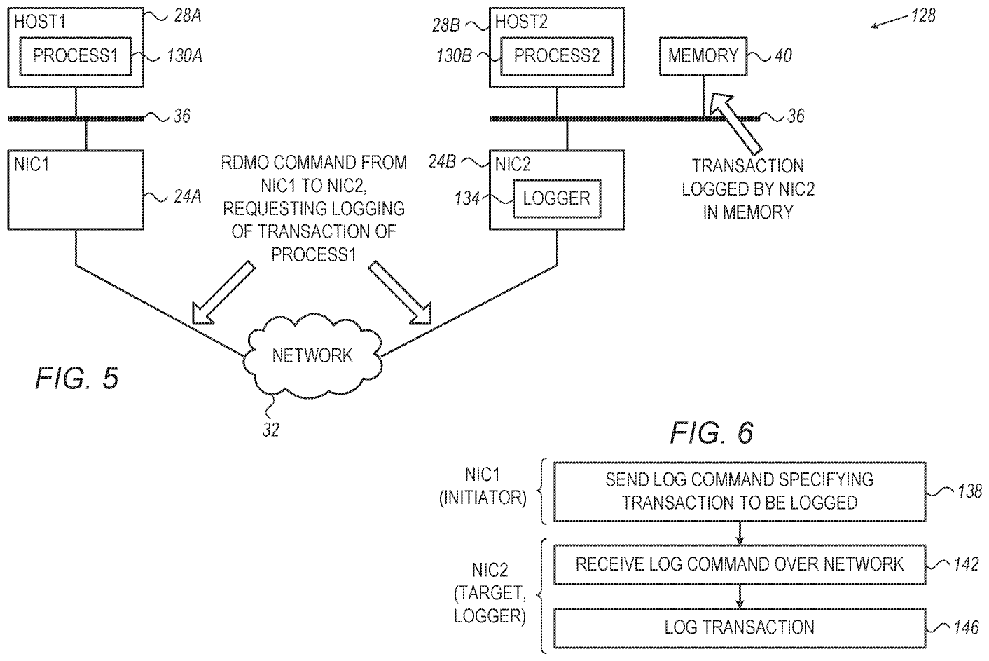

FIG. 5 is a block diagram that schematically illustrates a computing system 128 employing remote logging using RDMO, in accordance with an embodiment of the present invention. In system 128, host 28A (HOST1) runs a software process 130A denoted PROCESS1, and host 28B (HOST2) runs a software process 130B denoted PROCESS2.

NIC 24B (NIC2) comprises a logger 134 that logs software transactions to memory 40. Logger 134 may log software transactions of PROCESS1 and/or transactions of PROCESS2. If a process (PROCESS1 or PROCESS2) fails (e.g., because the host has crashed or for any other reason), logger 134 can recover the failed process using the log stored in memory 40. In a disclosed embodiment, NIC1 and NIC2 support an RDMO command that transfers one or more transactions of PROCESS1 from NIC1 and NIC2 for logging by logger 134.

FIG. 6 is a flow chart that schematically illustrates a method for remote logging using RDMO, in accordance with an embodiment of the present invention. The method begins with NIC1 sending a LOG RDMO command to NIC2, at a command sending stage 138. The LOG command specifies (e.g., comprises data and/or metadata of) a transaction of PROCESS1, and instructs NIC2 to log the transaction. At a command receiving stage 142, NIC2 receives the LOG command over network 32. At a logging stage 146, logger 134 in NIC2 logs the transaction in memory 40.

The configurations of systems 20 and 128, as shown in FIGS. 1 and 5, including the internal configurations of the network devices (e.g., NICs) and hosts in these systems, are example configurations that are chosen purely for the sake of conceptual clarity. In alternative embodiments, any other suitable configurations can be used. Elements that are not necessary for understanding the principles of the present invention have been omitted from the figures for clarity.

As with the other RDMO commands described herein, the LOG command is typically embedded in the transport protocol used between NIC1 and NIC2 (e.g., RDMA). NIC2 typically executes the command atomically in memory 40.

The various elements of systems 20 and 128, including the various disclosed network devices (e.g., NICs) and hosts, may be implemented in hardware, e.g., in one or more Application-Specific Integrated Circuits (ASICs) or FPGAS, in software, or using a combination of hardware and software elements. In some embodiments, certain elements of the disclosed network devices and/or hosts may be implemented, in part or in full, using one or more general-purpose processors, which are programmed in software to carry out the functions described herein. The software may be downloaded to any of the processors in electronic form, over a network, for example, or it may, alternatively or additionally, be provided and/or stored on non-transitory tangible media, such as magnetic, optical, or electronic memory.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A system, comprising:
a first network device, to send over a network a command that (i) specifies a memory location, a compare value and a swap value and (ii) instructs that the swap value be written into the memory location only if the compare value is larger than a current value in the memory location; and
a second network device, to receive the command over the network, and to execute the command by reading the current value from the memory location, comparing the current value to the compare value, and, upon finding that the compare value is larger than the current value, writing the swap value to the memory location in place of the current value.

2. The system according to claim 1, wherein the command is embedded in a transport protocol used by the first and second network devices.

3. The system according to claim 2, wherein the transport protocol is a Remote Direct Memory Access (RDMA) protocol.

4. The system according to claim 1, wherein the second network device is to execute the command atomically.

5. A network device, comprising:
a network interface, to connect to a network; and
processing circuitry, to send over the network a command that (i) specifies a memory location, a compare value and a swap value and (ii) instructs that the swap value be written into the memory location only if the compare value is larger than a current value in the memory location.

6. The network device according to claim 5, wherein the command is embedded in a transport protocol used by the network device.

7. The network device according to claim 6, wherein the transport protocol is a Remote Direct Memory Access (RDMA) protocol.

8. A network device, comprising:
a network interface, to connect to a network; and
processing circuitry, to:
receive over the network a command that (i) specifies a memory location, a compare value and a swap value and (ii) instructs that the swap value be written into the memory location only if the compare value is larger than a current value in the memory location; and
execute the command by reading the current value from the memory location, comparing the current value to the compare value, and, upon finding that the compare value is larger than the current value, writing the swap value to the memory location in place of the current value.

9. The network device according to claim 8, wherein the command is embedded in a transport protocol used by the network device.

10. The network device according to claim 9, wherein the transport protocol is a Remote Direct Memory Access (RDMA) protocol.

11. The network device according to claim 8, wherein the processing circuitry is to execute the command atomically.

12. A method, comprising:
sending, from a first network device, over a network, a command that (i) specifies a memory location, a compare value and a swap value and (ii) instructs that the swap value be written into the memory location only if the compare value is larger than a current value in the memory location; and
in a second network device, receiving the command over the network, and executing the command by reading the current value from the memory location, comparing the current value to the compare value, and, upon finding that the compare value is larger than the current value, writing the swap value to the memory location in place of the current value.

13. The method according to claim 12, wherein the command is embedded in a transport protocol used by the network device.

14. The method according to claim 13, wherein the transport protocol is a Remote Direct Memory Access (RDMA) protocol.

15. The method according to claim 12, wherein the processing circuitry is to execute the command atomically.
